(19) United States
(12) Patent Application Publication
(10) Pub. No.: US 2013/0074710 A1
(43) Pub. Date: Mar. 28, 2013

(54) SERVO PRESS AND SERVO PRESS CONTROLLING METHOD

(71) Applicants: Kazuhiro Kuboe, Kanagawa (JP); Akira Yamanouchi, Kanagawa (JP)

(72) Inventors: Kazuhiro Kuboe, Kanagawa (JP); Akira Yamanouchi, Kanagawa (JP)

(73) Assignee: AIDA Engineering, Ltd., Kanagawa (JP)

(21) Appl. No.: 13/608,174

(22) Filed: Sep. 10, 2012

(30) Foreign Application Priority Data
Sep. 26, 2011 (JP) 2011-209611

(51) Int. Cl. B30B 15/00; B30B 15/12; B30B 13/00; B30B 15/14

(52) U.S. Cl. 100/35; 100/50

(57) ABSTRACT

Provided is a low-cost servo press promoting energy saving by driving a press machine by a driving system suited for the magnitude of a load on a worked object. It includes a first motor coupled to a slide drive shaft to ascend/descend a slide, a second servo motor driving a flywheel, a clutch coupling/decoupling the second servo motor to/from the slide drive shaft, and a press controller controlling rotation of the first and second servo motors and coupling/decoupling of the clutch. The press controller controls to decouple the clutch when the press is small-loaded, thereby ascending/descending the slider by driving the first servo motor, and to couple the clutch when the press is large-loaded, thereby ascending/descending the slider by driving the first and second servo motors.

### BACKGROUND OF THE INVENTION

The present invention relates to a servo press and a method of controlling the servo press promoting size reduction and cost reduction.

In an existing servo press, a servo motor is requested to generate large energy desired for press working. Thus, when a converter which is the same as an inverter for servo motor in capacity is used, such a disadvantage occurs that the installed capacity of a primary power source is increased. Thus, a capacitor for energy storage is installed to perform peak-cut of primary power, thereby suppressing the installed capacity of the power source. However, since the size of the servo motor is increased with increasing the pressing ability, large energy is desired to control a total inertia of the large rotary inertia of the servo motor itself and the inertia of a mechanical drive unit, when a slide of the press starts/stops or is accelerated/decelerated in accordance with motion data for designating a motion. The energy has been absorbed so far by increasing the capacity of a capacitor so as to cope with taking in/out of the energy.

Japanese Patent Application Laid-Open No. 2003-230998 discloses an energy storage device and a press machine configured to reduce a fluctuation in power current when a servo press performs working as an example of related art of the servo press. It is a technology for suppressing the fluctuation in the power current by preparing an energy storage unit that includes a capacitor and a flywheel so as to cope with such a disadvantage of a normal servo press that the fluctuation in the power current is increased because a large driving current is desired for the motor in press working.

Although Japanese Patent Application Laid-Open No. 2003-230998 has such an advantage that the installed capacity of power source is suppressed by suppressing the fluctuation in the power current, a large capacity motor is still desired and hence such a disadvantage still remains that the cost of the servo press is high.

In addition, a press machine that ensures an optimum working speed and energy suited for press working is disclosed, for example, in Japanese Patent Application Laid-Open No. 2004-114119. In the technology disclosed in Japanese Patent Application Laid-Open No. 2004-114119, in order to eliminate such a disadvantage that the size of a servo motor used is increased in a servo press, another servo motor is added to a mechanical press that includes a flywheel so as to switchingly use them. Since it has a flywheel is used in press working, and a slide ascending/descending motion to be performed before and after press working is performed by the servo motor, such an advantage is obtained that size reduction of the servo motor is promoted. However, it is configured such that another servo motor is merely added to the mechanical press so as to move the servo motors separately from each other. Thus, the flywheel which is the same as an ever used one in size is desired and hence such a disadvantage still remains that the cost is increased accordingly in its power supply system or the like.

Further, for example, Japanese Patent Application Laid-Open No. 2008-307591 discloses a press machine that includes a plurality of motors, a flywheel for storing energy, a differential mechanism in which the flywheel and the plurality of motors are respectively connected to different rotors, and a slide that ascends/descends with rotation of one of the plurality of rotors, in which in the plurality of motors, at least one motor is used for power generation and at least the other one is driven.

Specifically, it includes two motors, a crank shaft is controlled by one motor and the flywheel is accelerated by the other motor in a high-speed section, energy is stored in the flywheel while regeneration is being performed by the other motor in a deceleration section, the energy is supplied from the flywheel to one motor on the principle of the differential mechanism by driving one motor and by performing deceleration by the other motor in a press section, by which the torque of one motor and the torque of the other motor are added together to develop large torque in the crank shaft.

### SUMMARY OF THE INVENTION

In general, press working is performed while alternately changing a plurality of molds for one press in many cases, rather than performing working by using only one dedicated mold, and loads (torque and energy) are greatly varied depending on the molds and materials used.

In an existing servo press, since a pressure capacity which is large enough for press working is generated with the torque of a servo motor used, the size of the servo motor itself is increased. As a result, the inertia of a rotor used is also increased and hence large energy is desired at start and stop of the press. Also in the above mentioned technologies disclosed in related art, since the capabilities of the motor and the flywheel are determined conforming to a situation that the load on a press-worked object (an object to be press-worked) is maximized, large energy is desired at start and stop of the press. In addition, since the inertia of the driving system is increased in the press machine of the type that the plurality of motors are connected together and driven by the differential mechanism, large energy is desired at start and stop of the press.

If it is allowed to reduce the size of a servo motor used when a press-worked object is small-loaded, it will be allowed to reduce the inertia of a rotor used and use of large energy as in the above mentioned examples will be avoided at start and stop of the press.

The present invention has been made in view of the above mentioned points and aims to provide a low-cost servo press that promotes energy saving by driving a press machine by a driving system suited for the magnitude of the load on the press-worked object.

In order to eliminate the above mentioned disadvantages, according to an embodiment of the present invention, there is provided a servo press that includes a servo motor coupled to a drive shaft of a slide to ascend/descend the slide, a flywheel motor for driving a flywheel, a clutch for coupling/decoupling the flywheel motor to/from the drive shaft of the slide and a press controller for controlling ion of the servo motor and the flywheel motor and coupling/decoupling of the clutch, wherein the press controller controls to decouple the clutch when the press is small-loaded, thereby ascending/descending the slide by driving the servo motor, and to couple the clutch when the press is large-loaded, thereby ascending/descending the slide by driving the servo motor and the flywheel motor.

The servo press further includes an inverter for controlling the servo motor and an inverter for controlling the flywheel motor, wherein the press controller controls to decouple the clutch when the press is small-loaded, thereby decelerating the flywheel motor when the servo motor is accelerated and accelerating the flywheel motor when the servo motor is decelerated to supply regenerative electric power of one motor so decelerated to the other motor so accelerated.

The servo press further includes an inverter for controlling the servo motor and an inverter for controlling the flywheel motor, wherein the press controller controls to couple the clutch when the press is large-loaded, thereby controlling the servo motor and the flywheel motor to have the same rotating speed.

In order to solve eliminate the above mentioned disadvantages, according to an embodiment of present invention, there is also provided a method of controlling a servo press that includes a servo motor coupled to a drive shaft of a slide to ascend/descend the slide, a flywheel moor for driving a flywheel and a clutch for coupling/decoupling the flywheel motor to/from the drive shaft of the slide, thereby performing pressing by a press controller controlling the respective units, and the method that includes decoupling the clutch when the press is small-loaded, thereby ascending/descending the slide by driving the servo motor, and coupling the clutch when the press is large-loaded, thereby ascending/descending the slide by driving the servo motor and the flywheel motor under the control of the press controller.

The method of controlling the servo press further includes decoupling the clutch when the press is small-loaded, thereby decelerating the flywheel motor when the servo motor is accelerated, and accelerating the flywheel motor when the servo motor is decelerated to supply regenerative electric power of one motor so decelerated to the other motor so accelerated.

The method of controlling the servo press further includes coupling the clutch when the press is large-loaded, thereby controlling the servo motor and the flywheel motor to have the same rotation speed.

The present invention provides the low cost servo press that attains optimum energy saving in accordance with the loaded state of the worked object by including the flywheel motor (hereinafter referred to as FM) which is relatively smaller in inertia than a flywheel of an existing mechanical press and a clutch for coupling/decoupling the FM to/from the slide drive shaft, in addition to the servo motor (hereinafter referred to as SM) for driving the slide.

The press is driven only by the SM by decoupling the clutch of the FM when the press-worked object is small-loaded, the FM performs regenerative braking when the SM performs power running, and the FM performs power running when the SM performs regenerative braking, by which the FM is allowed to have a function of storing energy desired for driving the SM. While, the clutch of the FM is coupled to rotate the FM at the same rotating speed as that of the SM when the press-worked object is large-loaded, thereby working the object by utilizing the torque of the SM, the torque of the FM, and the rotational energy derived from the inertia of the flywheel of the FM.

In addition, size reduction of the SM and the flywheel is allowed by switching the operating action mode in accordance with the magnitude of the load on the press-worked object, and load reduction of a primary power source is allowed by effectively utilizing the motor torques developed in the SM and the FM and the rotational energy derived from the inertia of the flywheel of the FM. Further, since it is allowed to reduce mechanical loss and electrical loss incidental to large-sizing of the SM, provision of the energy-saved and low-cost servo press is allowed.

According to embodiments of the present invention, when the load on the object to be press-worked by the servo press is varied, it is driven by switching to the driving system which is suited for the magnitude of the load and the energies of the plurality of driving systems are mutually sent and received efficiently at start and stop of them, by which energy saving and cost reduction of the servo press may be promoted.

### BRIEF DESCRIPTION OF THE DRAWINGS

FIG. 1 is a sectional diagram illustrating an example of a servo press according to an embodiment of the present invention, when viewed from front;

FIG. 2 is a cross-sectional diagram taken along A-A line in FIG. 1, similarly illustrating the example of the servo press;

FIG. 3 is a configuration diagram illustrating an example of a control system;

FIG. 4A, FIG. 4B, FIG. 4C, FIG. 4D and FIG. 4E are reference diagrams illustrating energy states of a general servo press;

FIG. 5A, FIG. 5B, FIG. 5C, FIG. 5D, FIG. 5E and FIG. 5F are diagrams illustrating examples of energy states observed when the press is small-loaded according to an embodiment of the present invention; and

FIG. 6A, FIG. 6B, FIG. 6C, FIG. 6D, FIG. 6E and FIG. 6F are diagrams illustrating examples of energy states observed when the press is large-loaded according to an embodiment of the present invention.

### DETAILED DESCRIPTION OF THE PREFERRED EMBODIMENTS

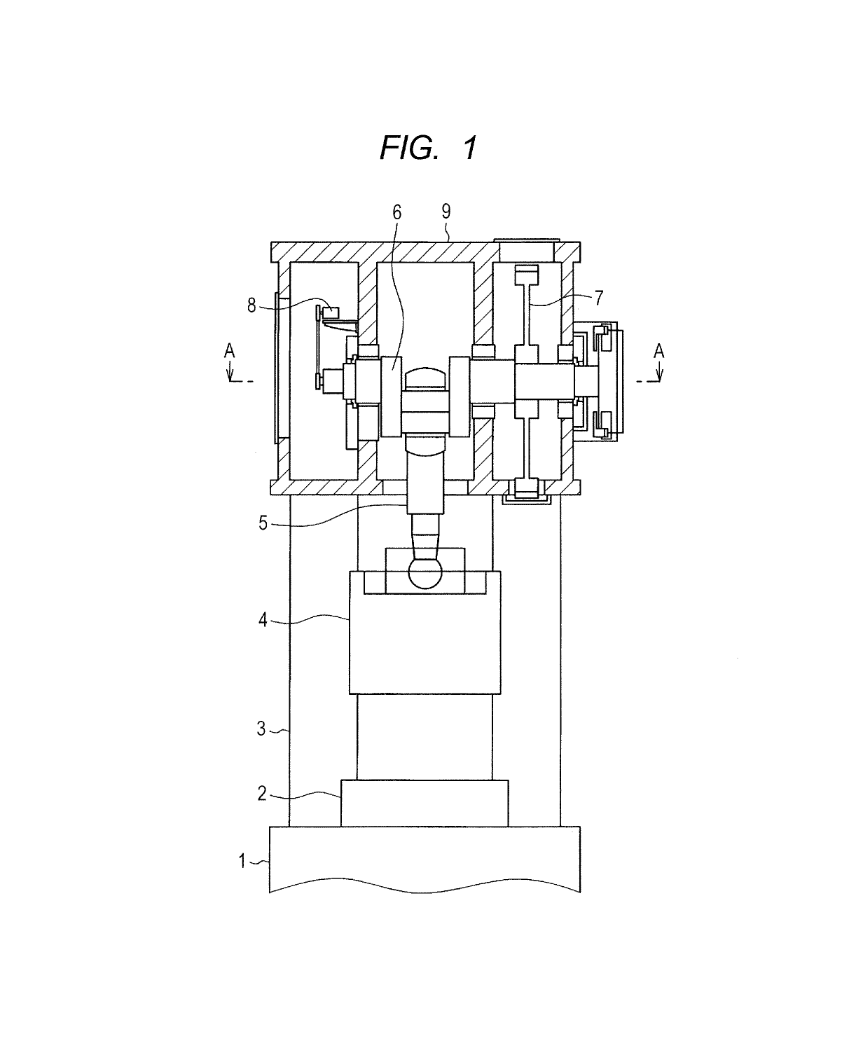

FIG. 1 is a sectional diagram illustrating an example of a servo press according to an embodiment of the present invention, when viewed from front. In FIG. 1, 1 is a bed that supports the servo press, 2 is a bolster disposed on the bed, 3 is a column erected on the bed, 4 is a slide that performs ascending and descending operations, 5 is a con-rod that connects a crank shaft 6 with the slide 4, 7 is a main gear that rotationally drives the crank shaft 6, 8 is a press encoder that detects the angle of rotation of the crank shaft 6, and 9 is a crown fixed onto the column 3 and adapted to contain and fix the above mentioned respective components.

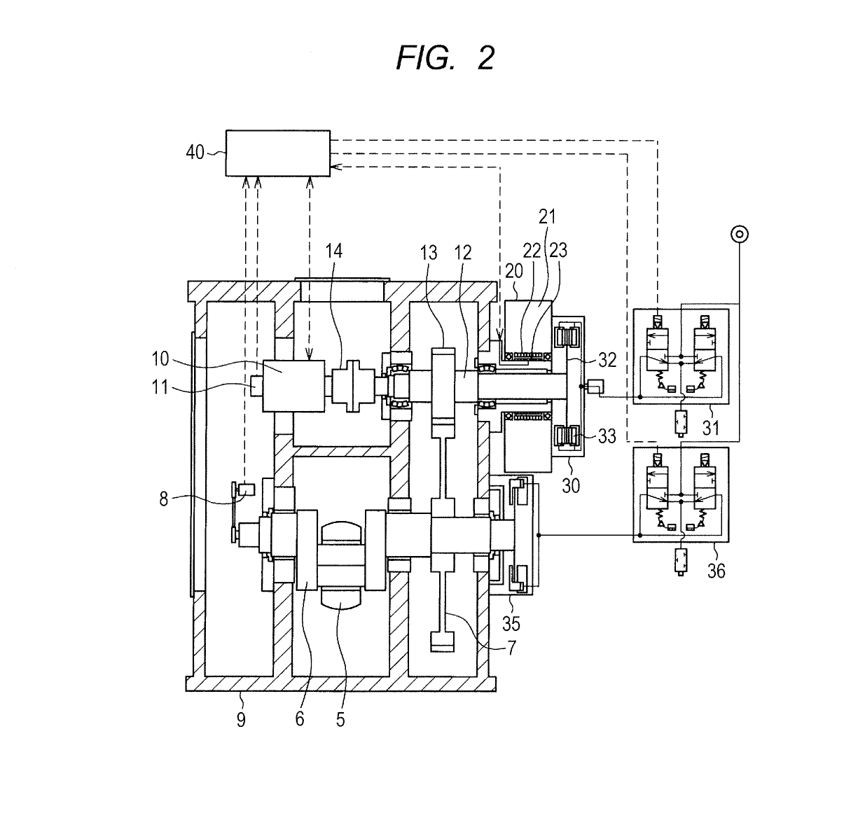

FIG. 2 is a cross-sectional diagram taken along A-A line in FIG. 1. In FIG. 2, 10 is a servo motor (hereinafter, referred to as the SM) that is coupled to a drive shaft of the slide to ascend/descend the slide, 11 is a motor encoder that detects the angle of rotation of the SM 10, and 12 is a drive shaft that is rotationally driven by the SM 10, that is, the drive shaft of the slide 4. 13 is a pinion gear that rotates together with the drive shaft and meshes with the main gear 7 to rotationally drive the main gear. 14 is a coupling that couples together the SM 10 and the drive shaft 12.

20 is a flywheel motor (hereinafter, referred to as the FM) that rotationally drives a flywheel body 21 and includes an internally disposed stator 23 and an externally disposed rotor 22. The stator 23 is fixed onto the inner peripheral side of the flywheel body 21. The flywheel body 21 has inertia which is smaller than that of an existing mechanical press.

30 is a clutch that couples/decouples the FM 20 to/from the drive shaft 12 of the slide 4 and its coupling/decoupling operations are controlled by a clutch electromagnetic valve 31. A disk 32 fixed to the drive shaft 12 is disposed within the clutch 30, the flywheel body 21 and the disk 32 are coupled together when a drive unit 33 grasps the both sides of the disk 32, and the flywheel 21 and the disk 32 are decoupled from each other by releasing grasping by the drive unit 33. When the flywheel body 21 and the disk 32 are coupled together, the flywheel body 21 and the drive shaft 12 are coupled together and are rotationally driven at the same speed.

35 is a brake mechanism that is connected to an axis of rotation of the main gear 7 and is driven by a brake electromagnetic valve 36 to apply the brakes to the axis of rotation of the main gear 7.

40 is a press controller that controls rotation of the SM 10 and the FM 20 with control signals indicted by broken lines, controls coupling/decoupling of the clutch 30 and controls the brake mechanism 35. Input signals are input into the press controller 40 from the press encoder 8 and the motor encoder 11.

The SM 10 and the pinion gear 13 are coupled together or integrally configured by the coupling 14, and the turning force (torque) of the SM 10 is transmitted in order of the pinion gear 13, the main gear 7 and the crank shaft 6 under the command from the press controller 40. The con-rod 5 is rotatably coupled to the crank shaft 6 and the slide 4 is vertically driven by the con-rod 5. On the other hand, the turning force (torque) of the FM 20 is transmitted to the pinion gear 13 via the clutch 30 under the command from the press controller 40. Air supply/cut-off to/from the clutch 30 is performed by operating the electromagnetic value 31 under the command from the press controller 40. The FM 20 includes the flywheel body 21, the rotor 22, the stator 23, and a bearing.

Here, it is supposed that the crank angle of the press machine is detected by the press encoder 8 that is disposed interlocking with the crank shaft 6 and respective crank angles corresponding to feed motion angles of a feeder in a working region are set in advance in the press controller 40.

The press machine starts from a set point such as, for example, a top dead center or the like, the press is driven only by the SM 10 by decoupling the clutch 30 when the press-worked object is small-loaded, and the FM 20 performs regenerative braking when the SM 10 performs power running, and the FM 20 performs power running when the SM 10 performs regenerative braking, by which the FM 20 is allowed to have the function of storing energy desired for driving the SM 10. In addition, the clutch 30 is coupled to rotate the SM 10 and the FM 20 at the same rotating speed when the press-worked object is large-loaded, by which the object is worked by utilizing the torques developed in the SM 10 and the FM 20 and the rotational energy derived from the inertia of the flywheel body 21 of the FM 20.

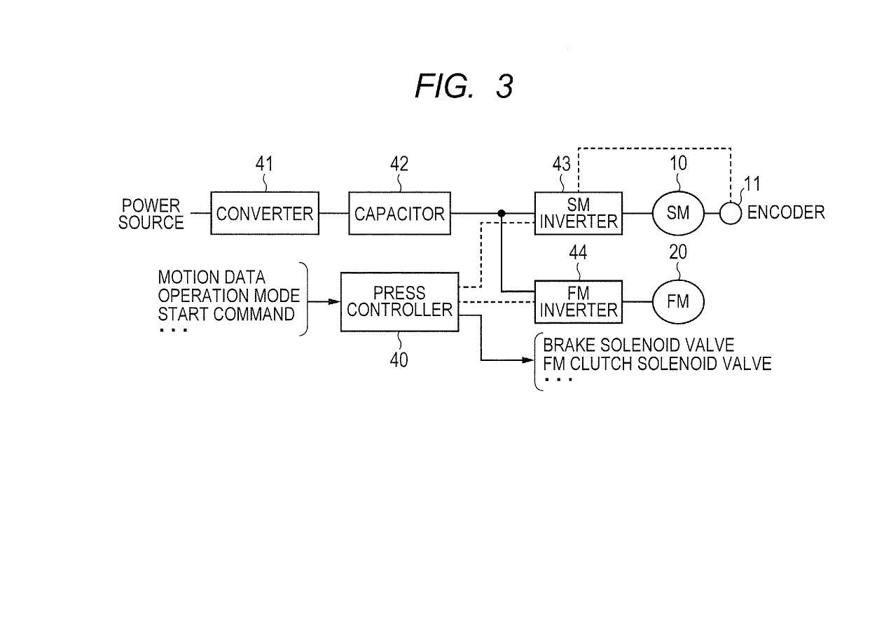

FIG. 3 is a configuration diagram illustrating an example of a control system. 41 is a converter that converts commercial AC power into DC energy and a capacitor 42 is charged with the DC energy so converted. 43 is an SM inverter that inverts DC power into power of an arbitrary frequency to control the SM 10, 44 is an FM inverter that inverts DC power into power of an arbitrary frequency to control the FM 20. The capacitor 42, the SM inverter 43 and the FM inverter 44 are connected with one another to allow delivery (transmission and reception) of the DC energies among them. In addition, since the SM 10 is allowed to indirectly read the slide position by the motor encoder 11 via a deceleration mechanism and a lever mechanism including the pinion gear 13 and the main gear 7 of the press drive unit, speed control and position control are allowed.

Motion data used to designate a motion of the press slide 4, an operation mode for selecting whether the FM 20 is used on the basis of the magnitude of the load on the press, a start command used to operate the slide 4 and the like are input into the press controller 40. In addition, commands used for speed control and position control of each motor and commands to the electromagnetic valve 36 for actuating the brake, the clutch electromagnetic valve 31 for the FM 20 and the like are output from the press controller 40.

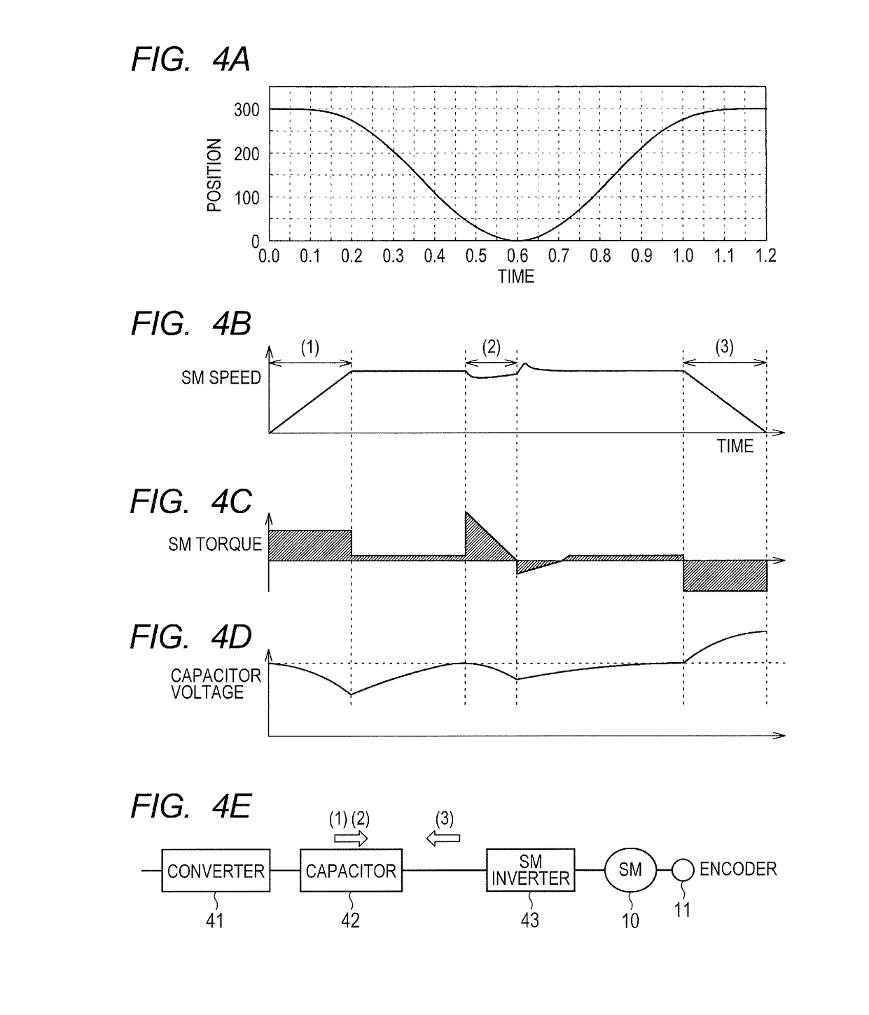

FIG. 4A to FIG. 4E are reference diagrams illustrating energy states of a general servo press. FIG. 4A illustrates an example of the slide position for indicating a moving state of the press, FIG. 4B illustrates an example of the rotating speed of an SM used therein, FIG. 4C illustrates an example of the torque developed in the SM, FIG. 4D illustrates an example of the capacitor voltage serving as a reference of an energy storage amount, and FIG. 4E illustrates an example of the flow of energy on a control block.

FIG. 4A to FIG. 4E illustrate examples of a case that press working is performed in a one-stroke operation of the press, assuming a motion that the slide 4 of the press starts from a state that it stops at a top dead center, it enters a working zone just before a bottom dead center, and it again stops at the top dead center after it has performed press working. Although the SM 10 starts to move the slide 4 in a start-up and acceleration zone (1), since the energy stored in the capacitor 42 is used to develop the torque used at start of the SM 10, the capacitor voltage is reduced. Although the capacitor is charged from the primary power source via the converter 41 incidentally to a reduction in the capacitor voltage, since the acceleration energy used at start of the press is large, discharge energy exceeds charge energy. As a result, the capacitor voltage is reduced in the start-up and acceleration zone.

Since the load torque is developed by performing press working in a working zone (2), the energy stored in the capacitor 42 is used as in the case in the acceleration zone (1). Although it is intended to stop the slide 4 after working in a deceleration zone (3), since regenerative energy which is generated with decelerating the SM 10 works in a direction of charging the capacitor 42 via the SM inverter 43, the capacitor voltage is increased.

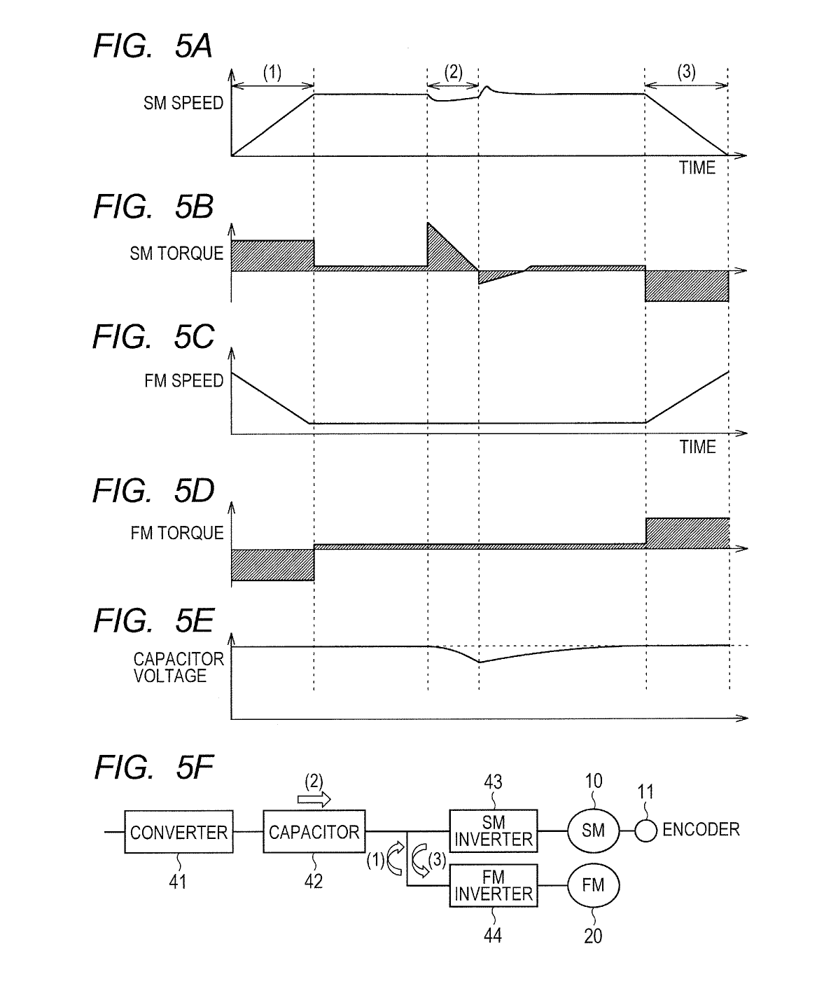

Next, a press working operation performed when the press is small-loaded according to an embodiment of the present invention will be described. FIG. 5A to FIG. 5F are diagrams illustrating examples of energy states observed when the press is small-loaded according to an embodiment of the present invention. FIG. 5A illustrates an example of the rotating speed of the SM 10, FIG. 5B illustrates an example of the torque developed in the SM 10, FIG. 5C illustrates an example of the rotating speed of the FM 20, FIG. 5D illustrates an example of the torque developed in the FM 20, FIG. 5E illustrates an example of the capacitor voltage serving as a reference of an energy storage amount, and FIG. 5F illustrates an example of the flow of energy on a control block. It is assumed that a small-loaded operation mode is set in advance on the press controller 40 by an operator and the clutch 30 of the FM 20 is in a decoupled state with a control signal from the press controller 40.

It is also assumed that FIG. 5A to FIG. 5F illustrate a case in which press-working is performed in a one-stroke operation of the press as in the case in FIG. 4A to FIG. 4e and the FM 20 is operated in a rated state before start of the SM 10.

The SM 10 accelerates rotation in a start-up and acceleration zone (2) and starts to move the slide 4 under the control of the press controller 40. The FM 20 is controlled to be decelerated with accelerating the SM 10 to generate regenerative power energy by deceleration. The regenerative power energy is supplied from the FM inverter 44 to the SM 10 via the SM inverter 43 and is used as energy for acceleration as indicated by (1) in FIG. 5F. The above mentioned state is illustrated as the SM torque that is developed in a plus direction when the SM 10 is accelerated in FIG. 5B and as the FM torque of the FM 20 that is developed in a minus direction with the regenerative energy in FIG. 5D.

In a working zone (2), since the clutch 30 is decoupled, the load torque caused by performing press working is developed only in the SM 10 and the energy stored in the capacitor 42 is used as in the case illustrated in FIG. 4A to FIG. 4E. Since this load torque is small, the slide 4 is descended only by the SM 10 to perform press working.

In a deceleration zone (3), the SM 10 is controlled to be decelerated by the press controller 40 so as to stop the slide 4 after press working has been performed. When the SM 10 is decelerated, the regenerative power energy is generated and the regenerative power energy so generated is supplied from the SM inverter 43 to the FM 20 via the FM inverter 44 and is used as energy for acceleration as indicated by (3) in FIG. 5F. The above mentioned state is illustrated as the SM torque that is developed in the minus direction when the SM 10 is decelerated in FIG. 5B and as the FM torque of the FM 20 that is developed in the plus direction with the regenerative energy in FIG. 5D. The FM 20 is operated in a rated state after accelerated.

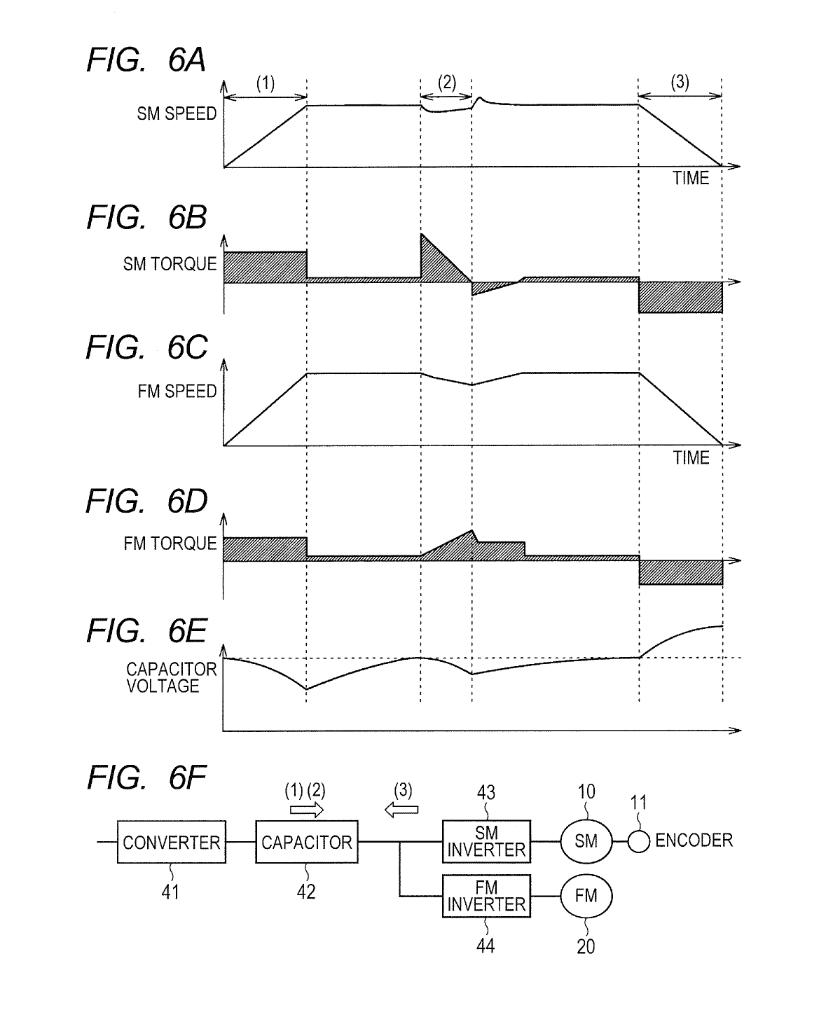

Next, a press working operation performed when the press is large-loaded will be described. FIG. 6A to FIG. 6F are diagrams illustrating examples of energy states observed when the press is large-loaded according to an embodiment of the present invention. FIG. 6A illustrates an example of the rotating speed of the SM 10, FIG. 6B illustrates an example of the torque developed in the SM 10, FIG. 6C illustrates an example of the rotating speed of the FM 20, FIG. 6D illustrates an example of the torque developed in the FM 20, FIG. 6E illustrates an example of the capacitor voltage serving as a reference of an energy storage amount, and FIG. 6F illustrates an example of the flow of energy on a control block. It is assumed that a large-loaded operation mode is set in advance on the press controller 40 by an operator and the clutch 30 of the FM 20 is in a coupled state with a control signal from the press controller 40.

FIG. 6A to FIG. 6F illustrates a case in which press working has been performed in a one-stroke operation of the press as in the case in FIG. 5A to FIG. 5F. When a load exerted in press working is large, also the FM 20 stops before the SM 10 starts in the examples illustrated in FIG. 6A to FIG. 6F. The SM 10 and the FM 20 that are in a coupled state under the control of the press controller 40 simultaneously start and are accelerated at the same speed to start to move the slide 4 in an acceleration zone (1).

In a working zone (2), since large load torque is desired for performing press working, the energy stored in the capacitor 42 is supplied to the SM 10 and the FM 20 to be used as in the case in FIG. 4A to FIG. 4E. The torque for press working is filled up with the torque to which the torques of two motors, that is, the SM 10 and the FM 20 and the operational energy of rotary motion derived from the inertia of the flywheel body 21 of the FM 20 itself are added. The above mentioned torques are illustrated as the SM torque and the FM torque that are developed in the plus direction in the working zone (2) in FIG. 6B and FIG. 6D.

Since the motor torque of the FM 20 and the operational energy of the rotary motion of the flywheel body 21 assist the motor torque of the SM 10 as described above, it is allowed to reduce the motor torques of both the SM 10 and the FM 20 and a reduction in the capacitor voltage is less than that of the general servo press illustrated in FIG. 4A to FIG. 4E.

In a deceleration zone (3), the press controller 40 controls to decelerate the SM 10 and the FM 20 so as to stop the slide 4 after press working has been performed. When the SM 10 and the FM 20 are decelerated, regenerative power energies are generated from the SM 10 and the FM 20 and the capacitor is charged with the regenerative power energies so generated via the SM inverter 43 and the FM inverter 44. The flow of the regenerative power energies is indicated by (3) in FIG. 6F and the respective regenerative power energies are illustrated as the SM torque and the FM torque that are developed in the minus direction in the deceleration zone (3) in FIG. 6B and FIG. 6D.

Incidentally, although the operator switches the operation mode depending on whether the press is small-loaded or lame-loaded in advance in the above mentioned embodiment, the operation performed by the operator may be omitted by configuring to automatically switch the operation mode in accordance with the energy desired for press working calculated by integration of press loads. In addition, it is allowed to set to the operation mode suited for the press load concerned by automatically switching decoupling/coupling of the FM clutch in the midst of operation.

In addition, although also the FM 20 stops before start of the SM 10 in the example illustrated in FIG. 6A to FIG. 6F, alternatively, the FM 20 may be typically rotated. In the latter case, the clutch 30 is decoupled at start of the SM 10 and the clutch 30 is coupled when the SM 10 is accelerated up to the same speed as that of the FM 20. Typical rotation of the FM 20 may lead to an increase in efficiency and energy saving when press working is continuously performed.

According to the embodiment of the present invention, it is allowed to provide the low-cost servo press that may attain energy saving in accordance with the load state of the worked object by including the FM which is smaller in inertia than the existing one and the clutch via which the FM is coupled/decoupled to/from the slide drive shaft, in addition to the SM for driving the slide.

The press is driven only by the SM by decoupling the clutch of the FM when the press-worked object is small-loaded, the FM performs regenerative braking when the SM performs power running, and the FM performs power running when the SM performs regenerative braking, by which the FM is allowed to have the function of storing energy desired for driving the SM. On the other hand, the clutch of the FM is coupled to rotate the FM at the same rotating speed as that of the SM when the press-worked object is large-loaded, by which it is allowed to perform press working by utilizing the torque developed in the SM, the torque developed the FM and the rotational energy derived from the inertia of the flywheel body of the FM.

In addition, size reduction of the SM, the FM and the flywheel thereof is allowed by switching the operating motion mode in accordance with the magnitude of the press working load, and it is allowed to reduce the load on the primary power source by efficiently utilizing the motor torques developed in the SM and the FM and the rotational energy derived from the inertia of the flywheel body of the FM. Further, since it is allowed to reduce the mechanical loss and the electrical loss incidental to large-sizing of the SM, provision of the energy-saved and low-cost servo press is allowed.

What is claimed is:

1. A servo press, comprising:
a servo motor coupled to a drive shaft of a slide to ascend/descend the slide;
a flywheel motor driving a flywheel;
a clutch coupling/decoupling the flywheel motor to/from the drive shaft of the slide; and
a press controller controlling rotation of the servo motor and the flywheel motor and coupling/decoupling of the clutch,
wherein, the press controller controls to decouple the clutch when the press is small-loaded, thereby ascending/descending the slide by driving the servo motor, and to couple the clutch when the press is large-loaded, thereby ascending/descending the slide by driving the servo motor and the flywheel motor.

2. The servo press according to claim 1, further comprising:
an inverter controlling the servo motor and an inverter controlling the flywheel motor,
wherein the press controller controls to decouple the clutch when the press is small-loaded, thereby decelerating the flywheel motor when the servo motor is accelerated and accelerating the flywheel motor when the servo motor is decelerated to supply regenerative electric power of one motor so decelerated to the other motor so accelerated.

3. The servo press according to claim 1, further comprising:
an inverter controlling the servo motor and an inverter controlling the flywheel motor,
wherein the press controller controls to couple the clutch when the press is large-loaded, thereby controlling the servo motor and the flywheel motor to have the same rotating speed.

4. In a method of controlling a servo press comprising:
a servo motor coupled to a drive shaft of a slide to ascend/descend the slide;
a flywheel motor driving a flywheel; and
a clutch coupling/decoupling the flywheel motor to/from the drive shaft of the slide, thereby performing pressing by a press controller controlling the respective units,
the method, comprising:
decoupling the clutch when the press is small-loaded, thereby ascending/descending the slide by driving the servo motor, and coupling the clutch when the press is large-loaded, thereby ascending/descending the slide by driving the servo motor and the flywheel motor under the control of the press controller.

5. The method of controlling the servo press according to claim 4, further comprising:
decoupling the clutch when the press is small-loaded, thereby decelerating the flywheel motor when the servo motor is accelerated, and accelerating the flywheel motor when the servo motor is decelerated to supply regenerative electric power of one motor so decelerated to the other motor so accelerated.

6. The method of controlling the servo press according to claim 4, further comprising:
coupling the clutch when the press is large-loaded, thereby controlling the servo motor and the flywheel motor to have the same rotation speed.
